(19) United States
(12) Patent Application Publication
(10) Pub. No.: US 2011/0223578 A1
(43) Pub. Date: Sep. 15, 2011

(54) FLEXIBLE FLASH CARD SYSTEM FOR CHILDREN, ADULTS, AND SPECIAL NEEDS INDIVIDUALS

(76) Inventor: Patricia K. Cooper, Hope, NJ (US)

(21) Appl. No.: 13/027,521

(22) Filed: Feb. 15, 2011

Related U.S. Application Data
(60) Provisional application No. 61/338,124, filed on Feb. 16, 2010.

(51) Int. Cl. G09B 25/00

(52) U.S. Cl. 434/429

(57) ABSTRACT

Disclosed is a soft, flexible, photo, face, or image recognition flash card game and system for children, adults, and special needs individuals. By utilizing the foam flash cards of various colors and shapes containing photographs of people, places, and familiar objects, a persons cognitive abilities can be developed and exercised.

### CROSS-REFERENCE TO RELATED APPLICATIONS

The present application claims the benefit of U.S. Provisional Application Ser. No. 61/338,124 filed 16 Feb. 2010 which is incorporated herein by reference in its entireties.

### TECHNICAL FIELD

The present invention relates to an educational device for improving cognitive development in children, adults, and impaired individuals and more particularly to an soft, flexible, photo face recognition flash card game and system for children, adults, and special needs individuals that utilizes foam flash cards of various colors and shapes containing photographs of family members and familiar objects and locations.

### BACKGROUND

Early development of a child's mental abilities can lead to success in all areas of life. Currently, available materials generally focus on the child's ability to associate words with standard pictures, colors, shapes, etc. Traditionally, flash cards containing various standard pictures of animals, shapes, or objects rather than written materials are used. These cards are generally arranged in sets to help develop a particular skill such as counting or reading. These cards, however, are typically standard and are not easily customizable by the user.

Furthermore, in today's society, with families living further and further apart, young children who do not regularly interact with distant relatives, tend to forget and/or not recognize their faces and images. To aid with this problem, family photos can be used, however, photo albums are often too bulky for infants and toddlers to handle and the photos often are damaged in the process. They are also typically not kid friendly, nor do they reinforce basic learning skills such as shape recognition or color recognition.

Similarly, as with children, adults suffering from various forms of dementia such as Alzheimer's disease or other ailments have difficulty remembering and/or recognizing faces of family members and friends. Constant reinforcement of familiar images via photographs may help with such problems.

Therefore, there exists a need for an educational device that can be easily customizable to include pictures and photographs of familiar images, that is safe for handling by a toddler or infant, and that incorporates in various colors, number, and shape recognition capabilities. The present invention addresses all these needs.

### SUMMARY

The devices disclosed herein relate to foam flash cards that allow a user to insert a picture or image into the flash card for easy customization. The flash card comprises a frame side and a shape side. The frame side typically has a frame or aperture cut out through which a photograph or picture can be viewed. Thorough repetitive viewing of the image a child or impaired person's cognitive, communicative and sensory abilities to recognize and associate faces, objects and images, with names of people and objects, can continually be reinforced.

The shape side typically contains a simple geometric shape cut out or aperture and is used to teach basic shapes and images. It may also be used as a location to place a trademark or logo. The flash card can be manufactured out of a single piece of materials and is typically formed into a pouch with at least one open edge though which an image may be inserted. Furthermore, to protect the inserted image, a transparent film or pouch is inserted within the frame pouch to protect the image.

Features and advantages of the present invention will become apparent to one skilled in the art upon examination of the following detailed description, when read in conjunction with the accompanying drawings. It is intended that all such features and advantages be included herein within the teachings of the present invention, as set forth herein and as sought to be protected by the claims.

### BRIEF DESCRIPTION OF THE DRAWINGS

The system and method, in accordance with one or more embodiments, is described in detail with reference to the following drawings. The drawings are provided for purposes of illustration only and merely depict typical or example embodiments. These drawings are provided to facilitate the reader's understanding and shall not be considered limiting of the breadth, scope, or applicability of the disclosure. It should be noted that for clarity and ease of illustration these drawings are not necessarily made to scale.

Some of the figures included herein illustrate various embodiments from different viewing angles. Although the accompanying descriptive text may refer to such views as “top,” “bottom” or “side” views, such references are merely descriptive and do not imply or require that the embodiment be implemented or used in a particular spatial orientation unless explicitly stated otherwise.

FIG. 1 depicts a front view of a flex frame with an image inserted in accordance with an embodiment;

FIG. 2 depicts rear view of a flex frame in accordance with an embodiment;

FIG. 3. is a side view of a flex frame in accordance with an embodiment;

FIG. 4. is a side view of a flex frame in accordance with an embodiment;

FIG. 5 is perspective view of a flex frame with an image being inserted in accordance with an embodiment;

FIG. 6 is front view of a flex frame in accordance with an embodiment; and

FIG. 7 depicts a front view of a flex frame in accordance with an embodiment.

The figures are not intended to be exhaustive or limited to the precise form disclosed. It should be understood that the embodiments can be practiced with modification and alteration, and that it is limited only by the claims and the equivalents thereof.

### DETAILED DESCRIPTION

The present disclosure is described herein in terms of example embodiments. Descriptions in terms of these embodiments are provided to allow the various features to be portrayed in the context of an exemplary application. As will be clear to one of ordinary skill in the art, the devices and methods can be implemented in different and alternative embodiments without departing from the spirit of the invention.

Unless defined otherwise, all technical and scientific terms used herein have the same meaning as is commonly understood by one of ordinary skill in the present field of technology. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

While various embodiments have been described above, it should be understood that they have been presented by way of example only, and not of limitation. Likewise, the various diagrams may depict an example architectural or other configurations and is intended to aid in understanding the features and functionality that can be included. The discovery is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present inventions. Also, a multitude of different constituent module names other than those depicted herein can be applied to the various partitions.

Although, described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments, whether or not such embodiments are described and whether or not such features are presented as being a part of a described embodiment. Thus the breadth and scope of the present disclosure should not be limited by any of the above-described exemplary embodiments.

As will become apparent to one of ordinary skill in the art after reading this document, the illustrated embodiments and their various alternatives can be implemented without confinement to the illustrated examples. For example, block diagrams and their accompanying description should not be construed as mandating a particular architecture, geometry or configuration.

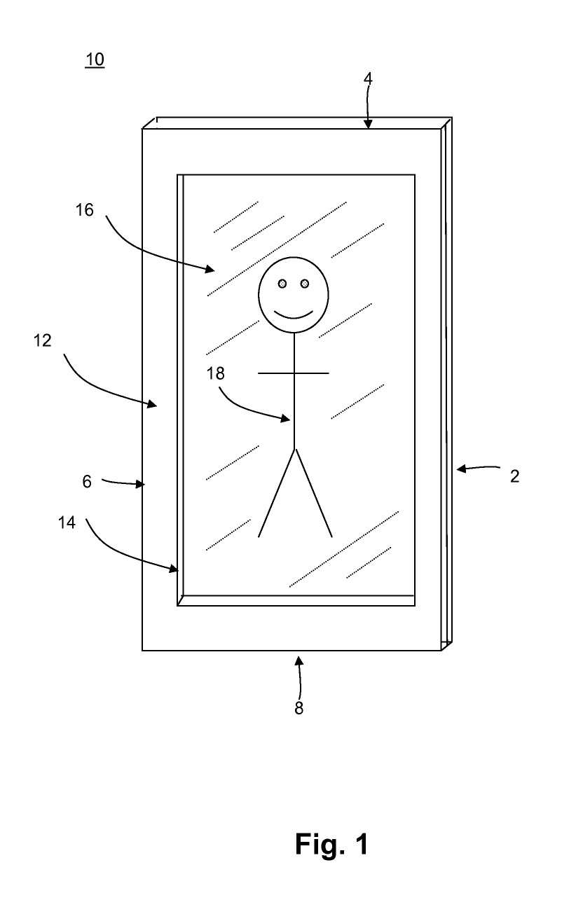

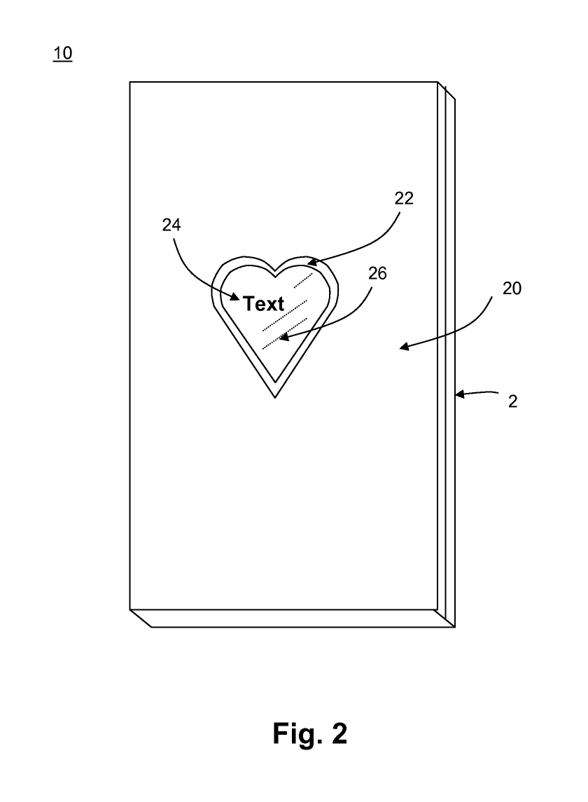

FIGS. 1 and 2 depict a flex flashcard frame 10 in accordance with one embodiment. Flex flashcard frame 10 includes a front side or frame side 12, an opening or aperture 14, a transparent sheet 16, a rear side or shape side 20, a rear cut out or rear aperture 22, text or rear image 24 printed on a medium, and rear transparent sheet 26. In FIG. 1, flex flashcard frame 10 is depicted with an image 18 already inserted into the flashcard. While depicted in rectangular form, it will be appreciated by those skilled in the art, that flex flashcard frame 10 may be any geometric shape, such as square, diamond, oval, heart shaped, or any other simple shape.

Frame side 12 and shape side 20 are typically joined on three edges to form a single pouch style object into which image 18 may be inserted through open edge 2. The flash card 10 may be composed of a single sheet of non toxic malleable or flexible materials or from separate pieces. If a single sheet is used, it may be formed into front side 12 and rear side 20 from the single sheet. The remaining edges, 4, 6, and 8 may be sealed using any known method, such as stitching, adhesive, heat bonding, or chemical bonding. If individual sheets are used, frame side 12 and shape side 20 may be joined together to form the pouch shape flashcard frame 10. Similar methods can be used to join frame side 12 and shape side 20 to form the unified pouch. It is to be understood that flashcard frame 10 must contain an open edge 2 into which image 18 may be inserted by the user. In one embodiment, it was found that a single sheet of ethylene vinyl acetate (EVA) foam about 2 mm in thickness was particularly suited for forming the flashcard frame 10. As will be understood by those skilled in the arts, other non toxic foam materials maybe used.

Prior to formation of flashcard frame 10 into a pouch, front aperture 14 and rear opening or aperture 22 should be cut from the materials. Any known technique may be used to cut the apertures, such as stamping or cutting. As will be appreciated by those skilled in the art, aperture 14 is not limited to the images depicted in the figures. While aperture 14 is typically square, rectangular, oval, or circular, it may be any geometric shape, such as a diamond, heart, circle, or it may be a simple shape such as a butterfly, tree, fish, or a dinosaur, and is only limited by the size of the flashcard frame 10.

Similarly, rear opening or aperture 22 may typically be a geometric shape such as a square, rectangle, hexagon, heart, diamond, or any other geometric shape, but it may be any simple image such as a car, truck, fish, letter, number, plane, tree, dinosaur, or any other image typically found in standard flash cards.

Internal to flashcard frame 10 are transparent sheets 16 and 26. Transparent sheets 16 and 26 are intended to protect the inserted image 18 from a user's fingers or other objects, such as a child's mouth, that may damage the image.

Transparent sheets 16 and 26 may be individual sheets affixed to the inside of front side 12 and rear side 20. In another embodiment, a transparent pouch 40 comprised of a front transparent sheet and a rear transparent sheet were utilized rather than individual sheets. In this manner, the transparent pouch 40 may be inserted into the frame 10 through open edge 2, thereby eliminating the need to affix individual sheets to frame side 12 and cut out side 20. In one embodiment a transparent pouch composed of 5 millimeter clear polyester was used.

Mounted in the inside face of rear transparent sheet 26, and positioned to be visible through rear aperture 22 may be text 24. Text 24 may be any text or additional image such as for example, a word describing the shape, or a logo or trademark, printed on a medium such as paper or card stock. In this way, the flashcard's use as a learning device or promotional device may be enhanced. For example, the word “circle” may appear through the shape of the circle or a company selling or marketing the flashcard frame may place its mark there.

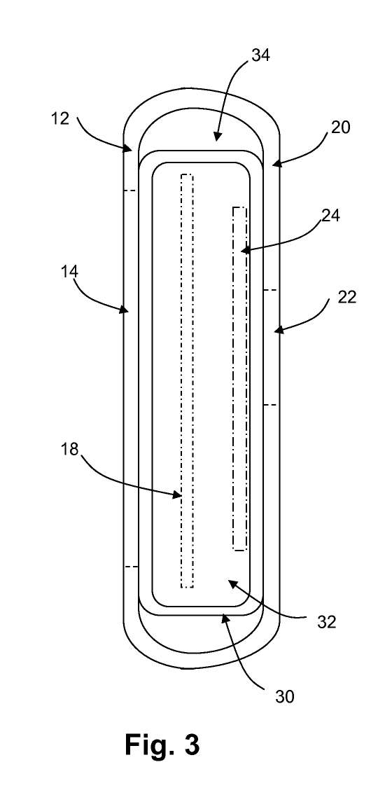

FIG. 3 depicts a side view of flex flashcard frame 10 viewed through the open edge 2. Cavity 34 is formed within the frame created by front side 12 and rear side 20. Inserted into cavity 34 is transparent pouch 30 forming cavity 32. Transparent pouch 30 contacts both front side 12 and rear side 20. Mounted on the rear side of transparent pouch 30 is text or image 24, such that it is viable through shape cut out or rear aperture 22. It will be understood, that because of the size and location of rear aperture 22, text or image 24 should be affixed to transparent pouch 30 to ensure that it remains visible from the outside of the flashcard frame. Also, seen in FIG. 3, transparent pouch 30 should be larger than aperture 14, and should typically be large enough to adequately display a standard 4×6 inch or 3×5 inch photo or image. Image 18 may be any image printed on a medium such as photo paper, regular paper or card stock, but any image or aperture size may be used.

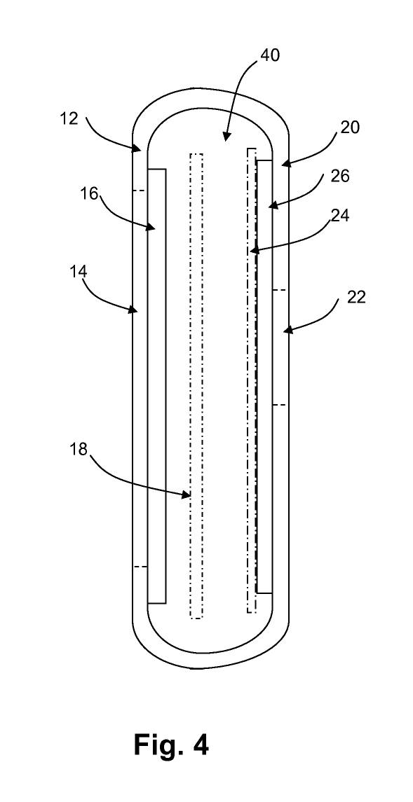

FIG. 4 depicts a side view of flex flashcard frame 10 in accordance with another embodiment. Cavity 40 is formed within the frame created by front side 12 and rear side 20. Inserted into cavity 40, are transparent sheets 16 and 26. Once inserted, into cavity 40 the transparent sheets, contact front side 12 and rear side 20, respectively. Mounted on rear transparent sheet 26 is text or image 24, such that it is viable through shape cut out or rear aperture 22. It will be understood, that because of the size and location of rear aperture 22, text or image 24 should be affixed to rear transparent sheet 26 to ensure that it remains visible from the out side of the pouch. As can be seen in FIG. 4, transparent sheet 16 should be larger than aperture 14, and should typically be large enough to adequately display a standard 4×6 inch or 3×5 inch photo or image. Image 18 may be any image printed on a medium such as photo paper, regular paper or card stock, but any image or aperture size may be used.

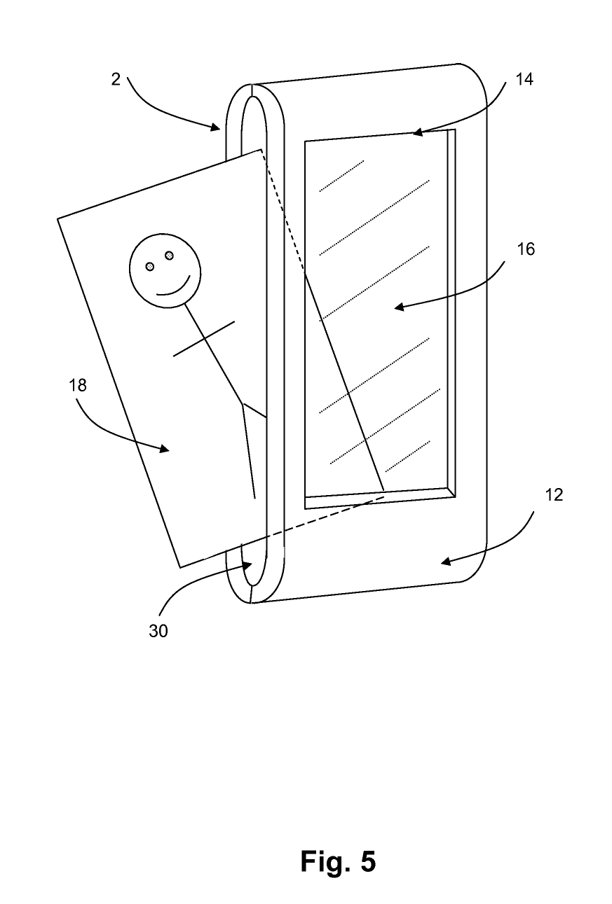

FIG. 5 depicts a perspective view of flashcard frame 10. As can be seen image 18 is inserted by a user into cavity 40 through open edge 2. Similarly, if transparent pouch 30 is utilized, image 18 would be inserted into cavity 32 within cavity 30.

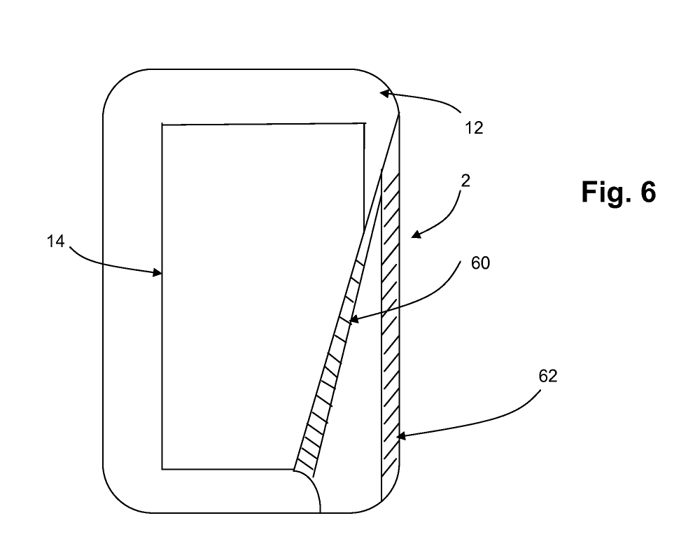

With respect to FIG. 6, and as noted above, frame side 12 and the shape side 20 form a pouch shape with open edge 2, through which image 18 may be inserted. Edge 2 contains a sealing strip which may be a single strip such as sealing strip 60 or may be composed of front strip 60 and rear strip 62, depending on the mechanism of sealing and the resalable nature of the sealing strip. As will be appreciated, by those skilled in the art, edge 2 may be sealed once image 18 is inserted to permanently create a flashcard, or it may remain open or be resealable to allow image 18 to be replaced by the user. Sealing strip 60 and 62, may be any mechanism that allows edge 2 to be sealed. For example, it may comprise two sided tape, glue, individual adhesive strips, a single adhesive strip, hook and loop materials or any other similar device used to keep edge 2 closed.

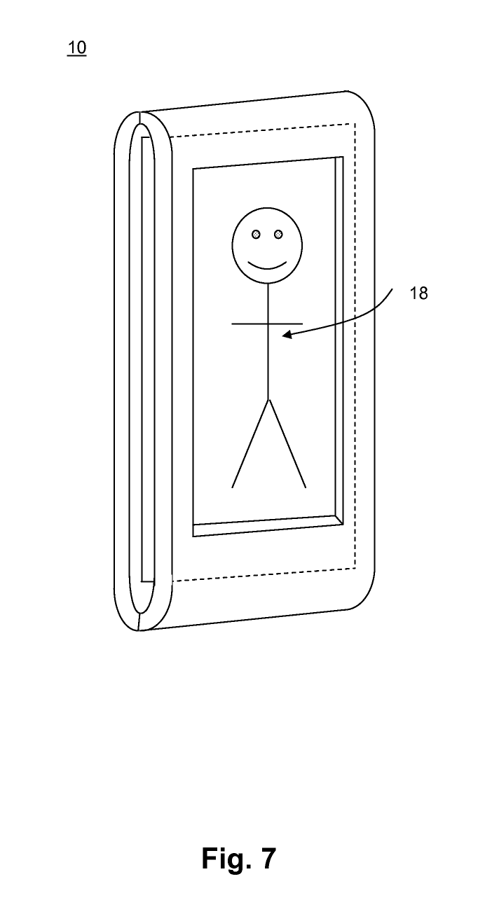

Flex flashcard 10, with image 18 installed as seen in FIG. 7 may be used to improve the cognitive, communicative and sensory abilities or learning skills of a subject, such as a child, an adult with dementia, or a special needs individual. For example, image 18 may be a picture of a family member, a pet, a distant relative, or a familiar location. By having a user, such as a parent or care giver show the specific image to the subject repeatedly along with a verbal description of the image, causes the subject to connect the images with the words, thereby improving the subject's cognitive, communicative and sensory abilities. Because image 18 is a specific image rather than a generic image, the subject is more likely to make the cognitive connection between the image and the verbalization. Furthermore, shape cut out 22 may be utilized to teach a subject such as a small child the name of simple shapes such as “circle.” The three-dimensional nature of shape cut out 22 also allows a child to trace the shape with a finger, thereby stimulating the tactile senses of the subject while at the same time, the verbal association is being reinforced by verbal repetition of the word.

While various embodiments have been described above, it should be understood that they have been presented by way of example only, and not of limitation. It should be further understood that the various features, aspects and functionality described in one or more of the individual embodiments are not limited in their applicability to the particular embodiment with which they are described, but instead can be applied, alone or in various combinations, to one or more of the other embodiments, whether or not such embodiments are described and whether or not such features are presented as being a part of a described embodiment. Thus the breadth and scope of the present disclosure should not be limited by any of the above-described exemplary embodiments.

As will become apparent to one of ordinary skill in the art after reading this document, the illustrated embodiments and their various alternatives can be implemented without confinement to the illustrated examples. For example, block diagrams and their accompanying description should not be construed as mandating a particular architecture, geometry or configuration.

1. A device for improving cognitive, communicative and sensory skills comprising:
an individual malleable flash card having a pouch with an open edge;
the pouch comprising a frame side with an aperture and a shape side with an aperture; and,
a first transparent sheet mounted inside the pouch and in contact with the frame side and a second transparent sheet located in the pouch and in contact with the shape side.

2. The device of claim 1 wherein the pouch is formed from a single sheet of malleable material.

3. The device of claim 2 wherein the malleable material is a foam material about 2 mm in thickness.

4. The device of claim 3 wherein the malleable material is an ethylene vinyl acetate (EVA) material.

5. The device of claim 1 wherein the first transparent sheet and the second transparent sheet form a transparent pouch.

6. The device of claim 1 further comprising an image printed on a medium and viewable through the frame side aperture.

7. The device of claim 1 wherein a text is visible through the shape side aperture.

8. The device of claim 1 wherein the shape side aperture's shape is chosen from one of the following:
a geometric shape, a letter shape, a number shape, an animal shape, a vehicle shape, a bug shape, a building shape, a heart shape, and a dinosaur shape.

9. The device of claim 1 further comprising a sealing strip located adjacent the open edge.

10. The device of claim 9 wherein the sealing strip is an adhesive strip.

11. The device of claim 9 wherein the sealing strip is resealable.

12. A method of improving cognitive, communicative, and sensory skills in a human comprising the following:
utilizing individual malleable flash cards comprising:
a foam pouch containing an image,
wherein the pouch comprises a frame side with an aperture and a shape side with an aperture;
aligning the image to be visible through the frame side aperture; and
repeatedly verbally identifying the image to the human.

13. The method of claim 12 wherein a word describing the shape of the shape side aperture is visible through the shape side aperture.

14. The method of claim 13 wherein the shape side aperture's shape is chosen from one of the following:
a geometric shape, a letter shape, a number shape, an animal shape, a vehicle shape, a bug shape, a building shape, a heart shape, and a dinosaur shape.

15. The method of claim 12 wherein the frame side and the shape side are formed from a single sheet of malleable material.

16. The method of claim 12 further comprising a transparent pouch within the flash card pouch.

17. The method of claim 16 wherein the image is inserted into the transparent pouch.

18. The method of claim 17 further comprising:
displaying the shape side aperture's shape to the child,
reading the word to the child, and
repeatedly verbally identifying the shape and the word to the child.

19. The method of claim 12 wherein the foam pouch is made from malleable material about 2 mm thick.

20. The method of claim 19 wherein the malleable material is an ethylene vinyl acetate (EVA) material.
